(19) United States
(12) Patent Application Publication
(10) Pub. No.: US 2010/0288120 A1
(43) Pub. Date: Nov. 18, 2010

(54) SINGLE-ACTING ROTARY ACTUATOR

(75) Inventor: Bruce R. Penning, Louisville, KY (US)

Correspondence Address: MARSHALL, GERSTEIN & BORUN LLP (FISHER), 233 SOUTH WACKER DRIVE, 6300 WILLIS TOWER, CHICAGO, IL, 60606, US

(73) Assignee: General Equipment and Manufacturing Company, Inc., d/b/a/ TopWorx, Inc. ("TopWorx"), Louisville, KY (US)

(21) Appl. No.: 12/466,983

(22) Filed: May 15, 2009

(51) Int. Cl. F15B 15/06; F16H 19/04; F16H 19/02

(52) U.S. Cl. 92/68; 74/89; 92/132; 92/136

(57) ABSTRACT

A rotary actuator comprises a housing, a shaft, at least one piston, and at least one closed-wound power spring coupled to the shaft. The housing defines a cavity. The shaft is disposed supported within the cavity of the housing and adapted for rotational displacement between a first position and a second position. The at least one piston is supported within the cavity of the housing and operatively coupled to the shaft. The piston is adapted for sliding displacement in association with rotational displacement of the shaft. The at least one closed-wound power spring is disposed within the cavity of the housing and operatively coupled to the shaft. So configured, the closed-wound power spring biases the shaft and the at least one piston into a predetermined relationship.

### FIELD OF THE DISCLOSURE

The present disclosure is generally related to rotary actuators and, more particularly, to single-acting, e.g., fail-open or fail-closed, rotary actuators.

### BACKGROUND

Conventional rotary actuators can include rack-and-pinion actuators and scotch-yoke actuators. Generally, these types of rotary actuators include a control assembly that can be displaced under the pressure of a pneumatic supply line, for example. In some rack-and-pinion and scotch-yoke actuators, the control assembly can include a pair of opposing pistons operatively linked to a rotatable shaft. Upon the pistons moving toward each other, the shaft rotates in a first direction. Upon the pistons moving away from each other, the shaft rotates in a second direction that is opposite the first direction.

Typically, the control assemblies of such conventional rotary actuators are controlled via one or more pneumatic inputs and can be categorized as either single-acting or double-acting. Double-acting actuators include two pneumatic inputs, a first for moving the pistons to rotate the shaft in the first direction, and a second for moving the pistons to rotate the shaft in the second direction. Single-acting actuators only include a single pneumatic input for moving the pistons either to rotate the shaft in the first or the second direction. To move the shaft in the other direction, single-acting actuators include a biasing mechanism such as a spring, for example, to bias the pistons, and therefore the shaft, into the desired position.

Single-acting rack-and-pinion and scotch-yoke actuators are typically equipped with one or more coil springs to achieve the desired bias. For example, FIG. 1 depicts a conventional single-acting rack-and-pinion actuator 10. The actuator 10 generally includes a housing 12, a pair of opposing pistons 14a, 14b, a rotatable shaft 16, and a plurality of coil springs 18a-18d. The springs 18a-18d are arranged between the pistons 14a, 14b and opposing end plates 12a, 12b of the housing 12 to bias the pistons 14a, 14b toward each another. To move the pistons 14a, 14b away from each other, the housing 12 defines a pneumatic inlet 20. Supplying a source of pressurized air, for example, to the pneumatic inlet 20 can move the pistons 14a, 14b apart and into the depicted position, thereby rotating the shaft 16 in a counter-clockwise direction relative to the orientation of the actuator 10 depicted in FIG. 1. Removing the supply of pressurized air from the inlet 20 allows the springs 18a-18d to bias the pistons 14a, 14b toward each other, thereby rotating the shaft 16 in a clockwise direction relative to the orientation of the actuator 10 depicted in FIG. 1.

One shortcoming of the configuration depicted in FIG. 1 is that the amount of torque applied to the shaft 16 by the springs 18a-18d, through the pistons 14a, 14b, is dependent upon the actual compression of the springs 18a-18d. That is, the more the springs 18a-18d are compressed, the more force they generate and apply to the pistons 14a, 14b, which in turn results in a greater amount of torque applied to the shaft 16. Therefore, the amount of torque generated by the springs 18a-18d is not constant throughout the stroke of the actuator 10, and this can lead to operating inefficiencies.

Another shortcoming of the actuator 10 depicted in FIG. 1 is due to the springs 18a-18d being positioned in portions of the housing 12 between the pistons 14a, 14b and the end plates 12a, 12b, which can be described as spring chambers. The spring chambers are sealed off from the cavity between the pistons 14a, 14b by the sealing engagement between the pistons 14a, 14b and the housing 12. Therefore, as the pistons 14a, 14b stroke between the open and closed states, plant air or atmosphere is drawn into and expelled from the spring chambers through openings (not shown) in the end plates 12a, 12b. A problem with drawing plant air or atmosphere into the spring chambers is that plant air or atmosphere can include moisture and other components that can corrode and possibly decrease the useful life of the springs 18a, 18b.

Yet another shortcoming of the depicted configuration is that it requires at least one spring 18a-18d to be assembled within the housing 12 for each piston 14a, 14b. The springs 18a-18d must be assembled into the spring chambers located between the pistons 14a, 14b and the end plates 12a, 12b, respectively. Moreover, in order to modify the actuator 10 to include different springs 18a-18d providing different loads, for example, the end plates 12a, 12b have to be removed from the housing 12 and new springs have to be installed. Such an assembly and replacement process can be time consuming and cumbersome.

### SUMMARY

One aspect of the present disclosure provides a rotary actuator including a housing, a shaft, at least one piston, and at least one closed-wound power spring. The housing defines a cavity. The shaft is disposed within the cavity of the housing and adapted for rotational displacement between a first position and a second position. The at least one piston is supported within the cavity of the housing and operatively coupled to the shaft. The piston is adapted for sliding displacement in association with rotational displacement of the shaft. The at least one closed-wound power spring is disposed within the cavity of the housing and operatively coupled to the shaft. So configured, the closed-wound power spring can bias the shaft and the at least one piston into a predetermined relationship.

In one embodiment, the closed-wound power spring comprises a first end fixed to the shaft and a second end fixed to the housing.

In one embodiment, the first end of the closed-wound power spring comprises a tongue extending at an angle to an innermost coil of the closed-wound power spring, the tongue being disposed within a radial slot defined by the shaft.

In one embodiment, the rotary actuator further comprises a threaded fastener supported by the housing and operatively coupled to the second end of the closed-wound power spring such that rotation of the threaded fastener relative to the housing adjusts the force of the closed-wound power spring.

In one embodiment, the at least one piston comprises a first piston and a second piston arranged on opposite sides of the shaft. The first and second pistons are slidable between a closed state when the shaft is in the first position, wherein the pistons are spaced a first distance apart, and an open state when the shaft is in the second position, wherein the pistons are spaced a second distance apart that is greater than the first distance.

In one embodiment, the at least one closed-wound power spring comprises first and second closed-wound power springs disposed within the housing and operatively coupled to the shaft.

In one embodiment, the rotary actuator further comprises an inlet defined by the housing and in fluid communication with the cavity containing the closed-wound power spring. The inlet is adapted to receive a supply of pressurized air for displacing the at least one piston and shaft relative to the housing.

In one embodiment, the at least one closed-wound power spring comprises at least one constant force clock spring.

Another aspect of the present disclosure provides a rotary actuator including a housing, a shaft, at least one piston, and a biasing mechanism. The housing defines a cavity. The shaft is disposed within the cavity and adapted for rotational displacement relative to the housing between a first position and a second position. The at least one piston is disposed within the cavity and operatively coupled to the shaft. The piston is movable relative to the shaft as the shaft rotates between the first and second positions. The biasing mechanism is coupled between the shaft and the housing and movable between a first state when the shaft is in the first position and a second state when the shaft is in the second position. The biasing mechanism applies a first force to the shaft when occupying the first state and a second force to the shaft when occupying the second state. The second force is substantially equal in magnitude to the first force.

In one embodiment, the first position of the shaft is at least forty-five degrees removed from the second position of the shaft.

In one embodiment, the first position of the shaft is ninety degrees removed from the second position of the shaft.

In one embodiment, the first position of the shaft is one-hundred and eighty degrees removed from the second position of the shaft.

In one embodiment, the biasing mechanism comprises a clock spring.

In one embodiment, the clock spring comprises a first end fixed to the shaft and a second end fixed to the housing.

In one embodiment, the first end of the clock spring comprises a tongue extending at an angle to an innermost coil of the clock spring. The tongue is disposed within a radial slot defined by the shaft.

In one embodiment, the rotary actuator further comprises a threaded fastener supported by the housing and operatively coupled to the second end of the clock spring such that rotation of the threaded fastener relative to the housing adjusts the force of the clock spring.

In one embodiment, the at least one piston comprises a first piston and a second piston arranged on opposite sides of the shaft. The first and second pistons are slidable between a closed state when the shaft is in the first position, wherein the pistons are spaced a first distance apart, and an open state when the shaft is in the second position, wherein the pistons are spaced a second distance apart that is greater than the first distance.

In one embodiment, the biasing mechanism comprises first and second clock springs disposed within the housing and operatively coupled to the shaft.

In one embodiment, the rotary actuator further comprises an inlet defined by the housing and in fluid communication with the cavity containing the biasing mechanism. The inlet is adapted to receive a supply of pressurized air for displacing the at least one piston and shaft relative to the housing.

Another aspect of the present disclosure provides a rotary actuator including a housing, a shaft, first and second pistons, and at least one clock spring. The housing defines a cavity. The shaft is supported in the cavity of the housing for rotational displacement between a first position and a second position removed one of approximately ninety degrees and approximately one-hundred and eighty degrees from the first position. The first and second pistons are disposed within the cavity and operatively coupled to the shaft. The first and second pistons are slidable between a closed state when the shaft is in the first position, wherein the pistons are spaced a first distance apart, and an open state when the shaft is in the second position, wherein the pistons are spaced a second distance apart that is greater than the first distance. The at least one clock spring is disposed in the cavity and biasing the shaft into one of the first and second positions. The clock spring includes a first end fixed to the shaft and a second end fixed to the housing such that the clock spring applies a constant torque to the shaft throughout the displacement of the shaft between the first and second positions.

In one embodiment, the first end of the clock spring comprises a tongue extending at an angle to an innermost coil of the clock spring, the tongue disposed within a radial slot defined by the shaft.

In one embodiment, the rotary actuator further comprises a threaded fastener supported by the housing and operatively coupled to the second end of the clock spring such that rotation of the threaded fastener relative to the housing adjusts the force of the clock spring.

One embodiment comprises first and second clock springs disposed within the cavity of the housing and biasing the shaft into one of the first and second positions.

In one embodiment, the rotary actuator further comprises an inlet defined by the housing and in fluid communication with the cavity containing the clock spring. The inlet is adapted to receive a supply of pressurized air for displacing the first and second pistons into one of the first and second states.

### BRIEF DESCRIPTION OF THE DRAWINGS

FIG. 1 is a cross-sectional top view of a conventional single-acting rack-and-pinion actuator.

FIGS. 2A and 2B are cross-sectional top views of a single-acting rack-and-pinion actuator in an open state and a closed state, respectively, constructed in accordance with the teachings of the present invention.

FIG. 3 is a cross-sectional side view of a first embodiment of the single-acting rack-and-pinion actuator of FIGS. 2A and 2B taken through line III-III of FIG. 2A.

FIG. 3A is a partial cross-sectional view of a shaft and biasing mechanism of the single-acting rack-and-pinion actuator of FIG. 3 taken through line IIIA-IIIA of FIG. 3.

FIG. 4 is a cross-sectional view of a second embodiment of the single-acting rack-and-pinion actuator of FIGS. 2A and 2B taken through line IV-IV of FIG. 2A.

FIGS. 5A and 5B are cross-sectional top views of a single-acting rack-and-pinion actuator in an open state and a closed state, respectively, constructed in accordance with the teachings of the present invention.

FIG. 6 is a cross-sectional side view of a first embodiment of the single-acting scotch-yoke actuator of FIGS. 5A and 5B taken through line VI-VI of FIG. 5A.

FIG. 7 is a cross-sectional side view of a second embodiment of the single-acting scotch-yoke actuator of FIGS. 5A and 5B taken through line VII-VII of FIG. 5A.

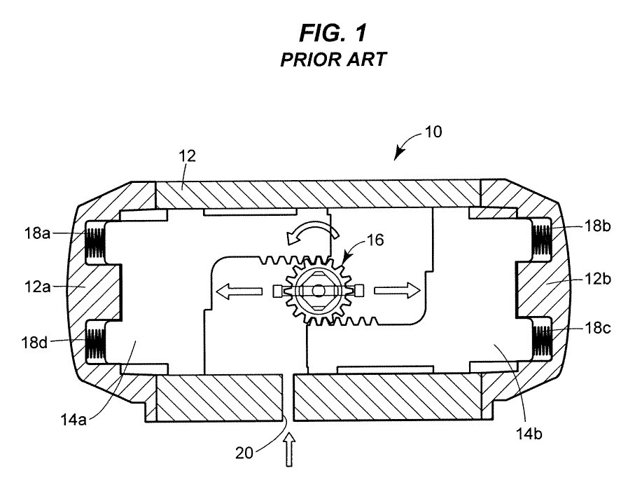

### DETAILED DESCRIPTION

Although the following text sets forth a detailed description of numerous different embodiments, it should be understood that the legal scope of the invention is defined by the claims set forth at the end of this patent. The detailed description is to be construed as containing one or more examples only and does not describe every possible embodiment since describing every possible embodiment would be impractical, if not impossible. Numerous alternative embodiments could be implemented, using either current technology or technology developed after the filing date of this patent, which would still fall within the scope of the claims.

It should also be understood that, unless a term is expressly defined in this patent using the sentence “As used herein, the term ‘______’ is hereby defined to mean . . . ” or a similar sentence, there is no intent to limit the meaning of that term, either expressly or by implication, beyond its plain or ordinary meaning, and such term should not be interpreted to be limited in scope based on any statement made in any section of this patent (other than the language of the claims). To the extent that any term recited in the claims at the end of this patent is referred to in this patent in a manner consistent with a single meaning, that is done for sake of clarity only so as to not confuse the reader, and it is not intended that such claim term be limited, by implication or otherwise, to that single meaning. Finally, unless a claim element is defined by reciting the word “means” and a function without the express or inherent recitation of structure, it is not intended that the scope of any claim element be interpreted based on the application of 35 U.S.C. §112, sixth paragraph.

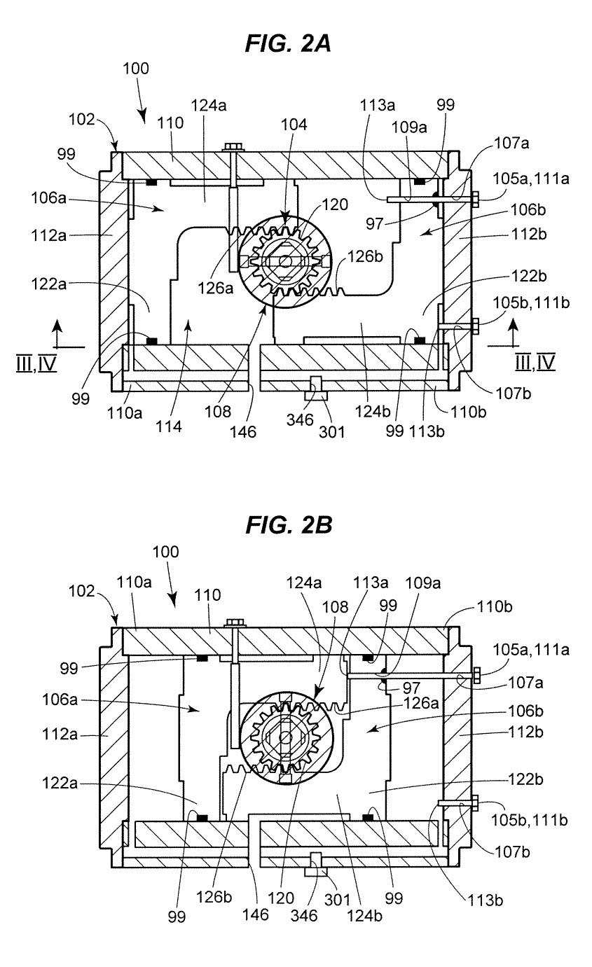

With reference back to the drawings, FIGS. 2A and 2B depict a single-acting rack-and-pinion actuator 100 (hereinafter referred to as “the actuator 100”) constructed in accordance with the principles of the present invention. In general, the actuator 100 includes a housing 102, a shaft 104, first and second pistons 106a, 106b, and a biasing mechanism 108. The biasing mechanism 108 is shown schematically in FIGS. 2A and 2B, but will be described in greater detail below.

The housing 102 includes a central cylinder portion 110 and first and second end plates 112a, 112b. The first and second end plates 112a, 112b are fixed to opposing first and second ends 110a, 110b of the central cylinder portion 110, respectively, such that the housing 102 defines a cavity 114.

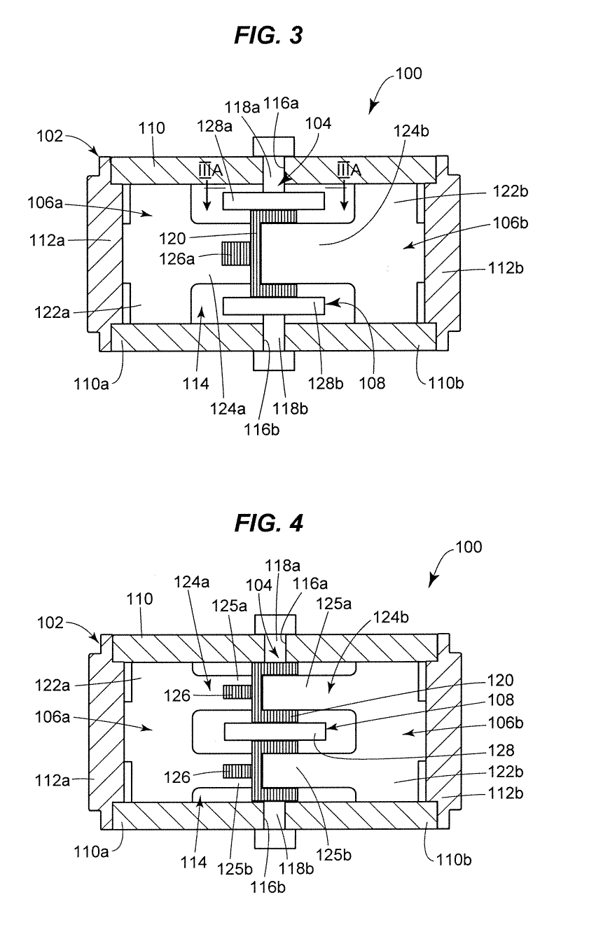

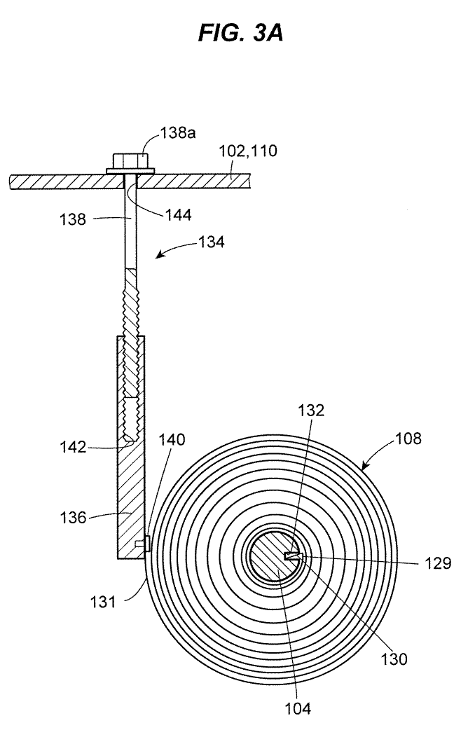

The shaft 104 of the depicted embodiment can be described as a pinion gear having a plurality of external gear teeth 120 spaced about the circumference and extending along a longitudinal direction of the shaft 104, as depicted in FIGS. 3 and 4, for example. The shaft 104 is supported within the cavity 114 of the housing 102 and adapted for rotational displacement between a first position, which is illustrated in FIG. 2A, and a second position, which is illustrated in FIG. 2B. In one embodiment, the first and second positions of the shaft 104 can be spaced at least approximately forty-five degrees (45°) apart. For example, in one embodiment, the first and second positions of the shaft 104 can be approximately ninety degrees (90°) apart for conventional butterfly type valve applications. In another embodiment, the first and second positions can be approximately one-hundred and eighty degrees (180°) apart, for example, for three-way valve configurations.

As depicted in FIGS. 3 and 4, the central cylinder portion 110 of the housing 102 includes top and bottom apertures 116a, 116b rotatably receiving top and bottom shaft portions 118a, 118b of the shaft 104, respectively. That is, the top and bottom shaft portions 118a, 118b are rotatably disposed within the top and bottom apertures 116a, 116b, respectively. In some embodiments, the actuator 100 may include one or more seals, for example, providing an airtight seal between the top and bottom shaft portions 118a, 118b and the top and bottom apertures 116a, 116b, respectively.

Referring back to FIGS. 2A and 2B, each of the first and second pistons 106a, 106b of the actuator 100 is also disposed within the cavity 114 of the housing 102 and is operatively coupled to the shaft 104 via the plurality of external gear teeth 120. The first piston 106a is positioned proximate to the first end 110a of the central cylinder portion 110 of the housing 102, while the second piston 106b is positioned proximate to the second end 110b of the central cylinder portion 110 of the housing 102.

As illustrated, each piston 106a, 106b includes a body portion 122a, 122b and an arm portion 124a, 124b. The body portions 122a, 122b can include generally disk-shaped members, the perimeters of which can be disposed in sealing engagement with one or more interior walls of the central cylinder portion 110 of the housing 102. In some embodiments, the actuator 100 can include a seal 99 disposed between each of the body portions 122a, 122b and the central cylinder portion 110 of the housing 102 to provide a fluid-tight seal for enabling pneumatic operation of the actuator 100, as will be described. The shape of the body portion 122a, 122b resembles that of a cross-section of the cavity 114 defined by the central cylinder portion 110 of the housing 102, which may be circular, square, rectangular, triangular, or generally any other conventional or unconventional geometric shape. The arm portions 124a, 124b of the pistons 106a, 106b extend from the respective body portions 122a, 122b toward and beyond the shaft 104, as depicted, and include rack gear portions 126a, 126b disposed in meshing engagement with the plurality of teeth 120 of the shaft 104.

During operation, the first and second pistons 106a, 106b are adapted for sliding displacement between an open state, which is illustrated in FIG. 2A, and a closed state, which is illustrated in FIG. 2B, in association with rotational displacement of the shaft 104 between the first and second positions. In the open state, the pistons 106a, 106b are spaced a first distance apart and, when in the closed state, the pistons 106a, 106b are spaced a second distance apart that is smaller than the first distance. The present embodiment of the actuator 100 includes first and second stroke limiting members 105a, 105b, which are illustrated in FIGS. 2A and 2B, for limiting the movement of the pistons 106a, 106b within the cavity 114 of the housing 102 and defining the spacing between the pistons 106a, 106b in the open and closed states.

In the disclosed embodiment, the first and second stroke limiting members 105a, 105b can include first and second pins 111a, 111b, respectively, extending into the housing 102. More specifically, the pins 111a, 111b are disposed through corresponding bores 107a, 107b formed in the second end plate 112b of the housing 102. The first pin 111a is of sufficient length that is also extends through a bore 109a formed in the body portion 122b of the second piston 106b. In one embodiment, either or both of the bore 109a and the first pin 111a can include a seal 97 (shown in FIGS. 2A and 2B) providing a sliding fluid tight seal between the first pin 111a and the body portion 122b of the second piston 106b. The first pin 111a further includes an end 113a disposed within the cavity 114 of the housing 102. The second pin 111b includes an end 113b disposed in a space between the second piston 106b and the second end plate 112b. So configured, the ends 113a, 113b of the pins 111a, 111b operate to limit the displacement of the pistons 106a, 106b between the open and closed states.

For example, as depicted in FIG. 2A, the end 113b of the second pin 111b is abutted by the body portion 122b of the second piston 106b when the pistons 106a, 106b occupy the open state. The second pin 111b therefore prevents the second piston 106b from displacing toward the second end plate 112b beyond the end 113b thereof. By limiting the displacement of the second piston 106b, the second pin 111b also limits the displacement of the first piston 106a because the first and second pistons 106a, 106b are operably coupled to each other via the shaft 104.

In contrast to the second pin 111b, the end 113a of the first pin 111a is abutted by the arm portion 124a of the first piston 106a when the pistons 106a, 106b occupy the closed state, as depicted in FIG. 2B. The first pin 111a therefore prevents the first piston 106b from displacing toward the second end plate 112b beyond the end 113a thereof. By limiting the displacement of the first piston 106a, the first pin 111a also limits the displacement of the second piston 106b because the first and second pistons 106a, 106b are operably coupled to each other via the shaft 104.

The pins 111a, 111b of the disclosed embodiment can be removable from the actuator 100 such that different pins having different lengths can be used. As such, the stroke limiting members 105a, 105b advantageously enable the stroke of the actuator 100 to be easily adjusted without requiring a complete dismantling of its component parts.

The biasing mechanism 108 of the disclosed embodiment is disposed within the cavity 114 of the housing 102 along with the shaft 104 and the pistons 106a, 106b and is operatively coupled to the shaft 104. So arranged, the biasing mechanism 108 biases the shaft 104 and the first and second pistons 106a, 106b into a predetermined relationship. For example, in the disclosed embodiment, the biasing mechanism 108 can bias the shaft 104 into the second position, thereby biasing the first and second pistons 106a, 106b together and into the closed state, as depicted in FIG. 2B. In another embodiment, however, the biasing mechanism 108 may bias the shaft 104 into the first position, thereby biasing the first and second pistons 106a, 106b apart and into the open state, as depicted in FIG. 2A.

The biasing mechanism 108 can include at least one closed-wound power spring or spiral-wound spring. A closed-wound power spring or spiral-wound spring is a type of spring that delivers a substantially constant magnitude of force throughout at least some extent to which it is wound or un-wound, for example. In one example, a closed-wound power spring or spiral-wound spring can deliver a substantially constant force throughout the entire extent to which it is wound or un-wound. In another example, a closed-wound power spring or spiral-wound spring can deliver a variable, e.g., increasing and/or decreasing, magnitude of force throughout the extent to which it is wound or un-wound. Such variable force springs could be utilized, for example, to overcome valve friction at closure or engagement of a seal in a rotary valve.

In one embodiment of the present application, the closed-wound power spring or spiral-wound spring can include a clock spring 128, as depicted in FIG. 3A. The clock spring 128 may be disposed within a cartridge or other housing, which is not illustrated in FIG. 3A, for preventing the coils of the clock spring 128 from displacing along the axis of the shaft 104. One example of a clock spring could include a constant force clock spring that provides a substantially constant amount of torque throughout a range of motion and, as will be described, throughout the stroke of the disclosed actuator 100. Another example of a clock spring could include a variable force clock spring that provides a variable, an increasing, and/or a decreasing amount of torque throughout a range of motion. In one embodiment, the clock spring 128 can be constructed as a flat ribbon of high tensile metal such as stainless steel or the like, which is commercially available from Vulcan Spring & Mfg. Co. of Telford, Pa., USA. In another embodiment, the clock spring 128 could include a NEG'ATOR spring, which is commercially available from Ametek Inc. of Paoli, Pa., USA.

As shown in FIG. 3A, the clock spring 128 of the disclosed embodiment of the actuator 100 can include a first end 129 coupled to the shaft 104 and a second end 131 coupled to the housing 102. More specifically, the first end 129 includes a tongue 130 disposed at an angle relative to the innermost coil of the clock spring 128. The tongue 130 is disposed within a radial slot 132 formed in the shaft 104. The second end 131 of the clock spring 128 is coupled to the housing 102 via an adjuster mechanism 134. The adjuster mechanism 134 is for adjusting the force or load of the clock spring 128. In the depicted embodiment, the adjuster mechanism 134 includes an adjuster block 136 and a threaded fastener 138. The adjuster block 136 is connected to the second end 131 of the clock spring 128 via a fastener 140 such as a screw, for example, and defines an internal threaded bore 142. The internal threaded bore 142 receives the threaded fastener 138, which extends therefrom and through an opening 144 in the central cylinder portion 110 of the housing 102.

So configured, the threaded fastener 138 can be rotated in a clockwise direction via a head portion 138a thereof to draw the adjuster block 136 toward the housing 102, which in turn draws the second end 131 of the clock spring 128 toward the housing 102 and tightens the coils of the clock spring 128 to increase the load bias applied to the shaft 104. Similarly, the threaded fastener 138 can be rotated via the head portion 138a thereof in a counter-clockwise direction to move the adjuster block 136 away from the housing 102, which in turn moves the second end 131 of the clock spring 128 away from the housing 102 and loosens the clock spring 128 to decrease the load bias on the shaft 104. So configured, the adjuster mechanism 134 provides a simple means of adjusting the force generated by the biasing mechanism 108 without requiring the housing 102 of the actuator 100 to be opened. Rather, a technician can simply adjust the threaded fastener 138 as described either by hand or with a tool such as a wrench, for example. In one embodiment, the threaded fastener 138 may further be equipped with a needle or other indicator extending radially from or printed on or adjacent to its head portion 138a, for example, and the housing 102 of the actuator 100 can include graduated markings circumferentially spaced about the opening 144. The graduated markings could foreseeably have predetermined forces associated therewith. As such, a technician would be able to easily adjust the force of the biasing mechanism 108 by simply turning the head portion 138a of the threaded fastener 138 such that the needle or other indicator becomes aligned with a graduated marking associated with a desired force.

Referring back to FIG. 3, a side view of one embodiment of the single-acting rack-and-pinion actuator 100 is illustrated, wherein the biasing mechanism 108 includes first and second clock springs 128a, 128b coupled to the shaft 104 and spaced apart by the plurality of external gear teeth 120. The first clock spring 128a is disposed on the shaft 104 adjacent the top shaft portion 118a, and the second clock spring 128b is disposed on the shaft 104 adjacent the bottom shaft portion 118b. Although not depicted, each of the first and second clock springs 128a, 128b is coupled between the shaft 104 and the housing 102 of the actuator 100 with an independent adjuster mechanism 134 that can resemble the adjuster mechanism 134 described above with reference to FIG. 3A. As such, the torque generated by each of the first and second clock springs 128a, 128b can be independently adjusted.

In the embodiment depicted in FIG. 3, the arms 124a, 124b of the pistons 106a, 106b are sized and configured to fit between the first and second clock springs 128a, 128b. So configured, the pistons 106a, 106b can move between the open state (FIG. 2A) and the closed state (FIG. 2B) without interfering with the operation of the clock springs 128a, 128b.

For example, during operation of the actuator 100 depicted in FIGS. 2A, 2B, and 3, the first and second clock springs 128a, 128b inherently bias the shaft 104 into the second position shown in FIG. 2B. When the shaft 104 occupies the second position, the first and second clock springs 128a, 128b occupy a first state and apply a first force, e.g., torque, to the shaft 104. The first state of the springs 128a, 128b can include a contracted state, which could also be referred to as a compressed state. Because the gear teeth 120 on the shaft 104 are in constant meshing engagement with the rack gear portions 126a, 126b of the arm portions 124a, 124b of the pistons 106a, 106b, the clock springs 128a, 128b therefore also bias the pistons 106a, 106b into the closed state, which is also depicted in FIG. 2B. To move the pistons 106a, 106b into the open state and thereby rotate the shaft 104 into the first position depicted in FIG. 2A, pressurized gas, such as supply air, can be delivered to the cavity 114 via an inlet 146 (shown in FIGS. 2A and 2B) in the central cylinder portion 110 of the housing 102.

While the open state of the pistons 106a, 106b is described with reference to FIG. 2A as comprising a state where the body portion 122b of the second piston 106b engages the end 113b of the second stroke limiting member 105b, the actual position of the second piston 106b and therefore the first piston 106a in the open state can alternatively be any position between the position depicted in FIG. 2B and the position depicted in FIG. 2A. The actual position in such an embodiment could, for example, be based on the magnitude of the pressure of the supply air provided to the inlet 146.

For example, with the state of the pistons 106a, 106b depicted in FIG. 2A, the pressure of the supply air is of sufficient magnitude to overcome the force of the biasing mechanism 108 such that the second piston 106b is displaced its maximum amount into engagement with the second stroke limiting member 105b. In this configuration, the force applied to the first and second pistons 106a, 106b by the supply air is greater than the force applied to the pistons 106a, 106b by the biasing mechanism 108.

However, during operation of the actuator 100, it is foreseeable that the force applied to the first and second pistons 106a, 106b by the supply air may be variable and based on some signal received from another aspect of the system. Therefore, at any given time, the force applied to the pistons 106a, 106b by the supply pressure may actually be less than the force applied by the biasing mechanism 108. In such a configuration, the open state of the pistons 106a, 106b and the second position of the shaft 104 can be based on, e.g., proportional to, the magnitude of the pressure of the supply air provided to the inlet 146. Accordingly, the open state of the pistons 106a, 106b can be defined by the pistons 106a, 106b occupying generally any state between that which is depicted in FIG. 2B and that which is depicted in FIG. 2A. Similarly, the second position of the shaft 104 can occupy generally any position between that which is depicted in FIG. 2B and that which is depicted in FIG. 2A.

When the shaft 104 occupies the first position, the clock springs 128a, 128b occupy a second state and apply a second force, e.g., torque, to the shaft 104. The second state of the springs 128a, 128b can include an extended state, which could also be referred to as an expanded state. Because the clock springs 128a, 128b of the disclosed embodiment can generate a force of substantially constant magnitude regardless of the state of winding they occupy, the first force applied to the shaft 104 when the springs 128a, 128b occupy the first state is substantially equal to the second force applied to the shaft 104 when the springs 128a, 128b occupy the second state. Moreover, the springs 128a, 128b apply a generally constant force to the shaft 104 at each and any position between the first and second positions. To return the shaft 104 to the second position and the pistons 106a, 106b to the closed state, the supply of pressurized air can be stopped, thereby allowing the clock springs 128a, 128b to urge the shaft 104 back to the position depicted in FIG. 2B.

While the biasing mechanism 108 of the actuator 100 has thus far been described as biasing the shaft 104 into the second position depicted in FIG. 2B, it can also be arranged to bias the shaft 104 into the first position depicted in FIG. 2A, as mentioned above. To facilitate such an arrangement, the shaft 104 and the biasing mechanism 108 can merely be flipped within the housing 102 such that the top shaft portion 118a is rotatably disposed within the bottom aperture 116b of the housing 102, and the bottom shaft portion 118b is rotatably disposed within the upper aperture 116a of the housing 102. So configured, the biasing mechanism 108 could bias the shaft 104 into the first position and the pistons 106a, 106b into the open state, as shown in FIG. 2A. To move the pistons 106a, 106b into the closed state and thereby rotate the shaft 104 into the second position depicted in FIG. 2B, pressurized gas, such as supply air, can be delivered into the housing 102 via a second inlet 346 in the central cylinder portion 110 of the housing 102. To access the second inlet 346, one embodiment of the actuator 100 can require a user to remove a plug 301 disposed therein. The plug 301 however is an optional feature and not necessarily required. The second inlet 346 is in fluid communication with a portion of the housing 102 disposed between at least one of the pistons 106a, 106 and the adjacent end plate 112a, 112b. So configured, pressurized air delivered through the second inlet 346 can apply a force to the body portion 122a, 122b of at least one of the pistons 106a, 106b thereby forcing the pistons 106a, 106b to move toward each other against the force of the biasing mechanism 108. Similar to that described above, exhausting the supply of pressurized air allows the biasing mechanism 108 to urge the pistons 106a, 106b and the shaft 104 back to the open state and second position, respectively.

Still further, while the actuator 100 depicted in FIG. 3 includes first and second clock springs 128a, 128b, alternative embodiments could include generally any number of clock springs 128. For example, FIG. 4 depicts one alternative actuator 100 that is structurally and functionally the same as the actuator 100 depicted in FIG. 3 with the exception of the number of clock springs 128 and the shape and configuration of the first and second pistons 106a, 106b.

Specifically, the actuator 100 depicted in FIG. 4 includes a single clock spring 128 mounted at a substantially centered position of the shaft 104 in a manner that can be identical to that described above with reference to FIG. 3A. To accommodate the centered position of the clock spring 128, the arm portion 124a, 124b of each of the pistons 106a, 106b of the actuator 100 depicted in FIG. 4 is forked and includes a top arm 125a and a bottom arm 125b. The top and bottom arms 125a, 125b of each arm portion 124a, 124b are spaced sufficiently to not interfere with the clock spring 128 when the pistons 106a, 106b move between the open and closed states. Moreover, the top and bottom arms 125a, 125b of each of the arm portions 124a, 124b includes a rack gear portion 126 in constant meshing engagement with the external gear teeth 120 of the shaft 104 to facilitate operation of the actuator 104, as discussed above.

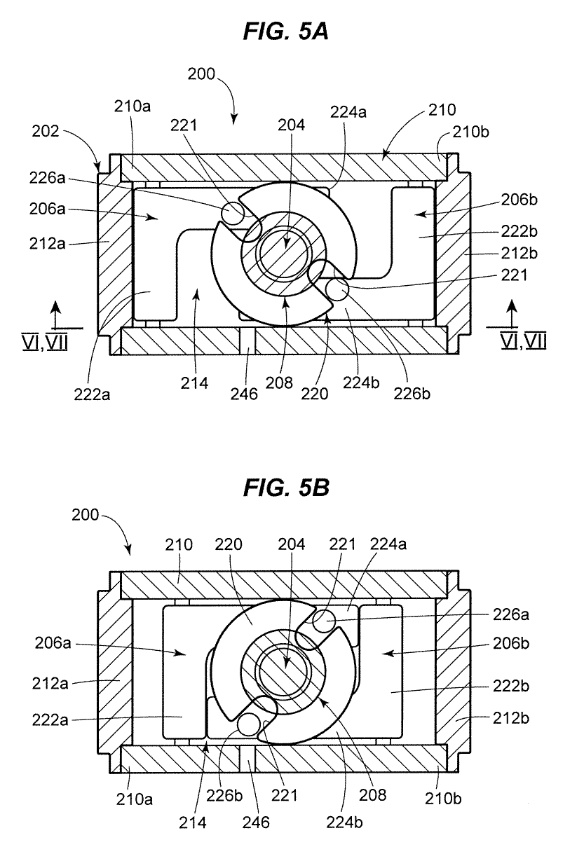

While the present disclosure has thus far discussed rack-and-pinion actuators 100, the disclosure is not necessarily limited to rack-and-pinion actuators. For example, FIGS. 5A and 5B depict an alternative embodiment of an actuator 200 constructed in accordance with the principles of the present disclosure, which includes a scotch-yoke type actuator 200 (hereinafter referred to as “the actuator 200”). The actuator 200 includes a housing 202, a shaft 204, first and second pistons 206a, 206b, and a biasing mechanism 208. The biasing mechanism 208 is shown schematically in FIGS. 5A and 5B, but can generally include any of the biasing mechanisms 108 described above with reference to the actuator 100 depicted in FIGS. 2-4.

The housing 202 of the actuator 200 is generally identical to the housing 102 of the actuator 100 described above in that it includes a central cylinder portion 210 and first and second end plates 212a, 212b. The first and second end plates 212a, 212b are fixed to opposing first and second ends 210a, 210b of the central cylinder portion 210, respectively, such that the housing 202 defines a cavity 214.

The shaft 204 of the depicted embodiment includes at least one yoke plate 220 extending radially therefrom and defining a pair of radial slots 221 disposed one hundred and eighty degrees (180°) from each other. The shaft 204, including the at least one yoke plate 220, is supported within the cavity 214 of the housing 202 and adapted for rotational displacement between a first position, which is illustrated in FIG. 5A, and a second position, which is illustrated in FIG. 5B. In one embodiment, the first and second positions of the shaft 204 can be spaced at least approximately forty-five degrees (45°) apart. For example, the first and second positions of the shaft 204 depicted in FIGS. 5A and 5B, respectively, can be approximately ninety degrees (90°) apart, as indicated by the differing positions of the radial slots 221 in the yoke plate 220.

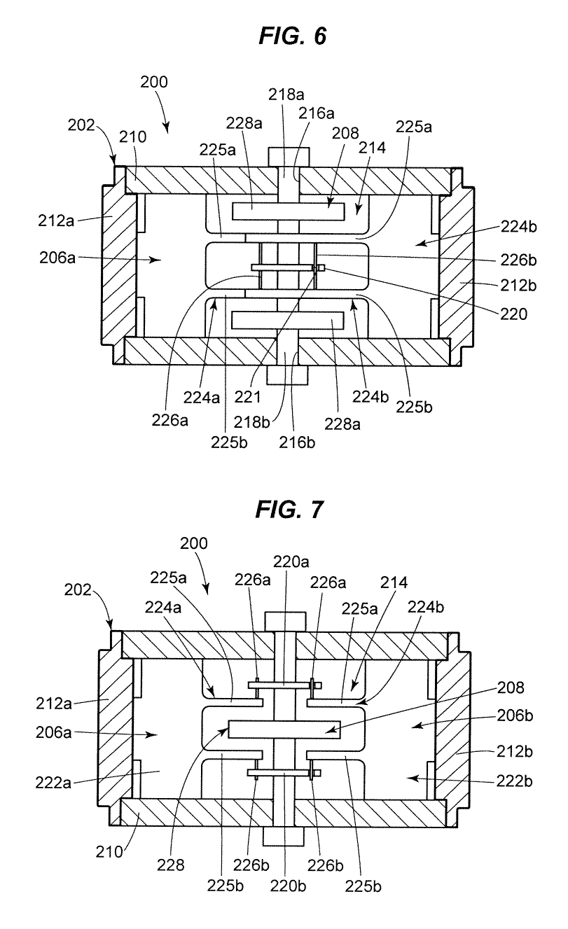

As depicted in FIG. 6, for example, the central cylinder portion 210 of the housing 202 of the actuator 200 includes top and bottom apertures 216a, 216b rotatably receiving top and bottom shaft portions 218a, 218b of the shaft 204, respectively. That is, the top and bottom shaft portions 218a, 218b are rotatably disposed within the top and bottom apertures 216a, 216b, respectively. In some embodiments, the actuator 200 may include one or more seals, for example, providing an airtight seal between the top and bottom shaft portions 218a, 218b and the top and bottom apertures 216a, 216b, respectively.

Referring back to FIGS. 5A and 5B, each of the first and second pistons 206a, 206b of the scotch-yoke actuator 200 is also disposed within the cavity 214 of the housing 202. The first piston 206a is positioned proximate to the first end 210a of the central cylinder portion 210 of the housing 202, while the second piston 206b is positioned proximate to the second end 210b of the central cylinder portion 210 of the housing 202. Each of the first and second pistons 206a, 206b is operatively coupled to the shaft 204 via the yoke plate 220 for sliding displacement between an open state, which is illustrated in FIG. 5A, and a closed state, which is illustrated in FIG. 5B, in association with rotational displacement of the shaft 204 between the first and second positions. In the open state, the pistons 206a, 206b are spaced a first distance apart and, when in the closed state the pistons 206a, 206b, are spaced a second distance apart that is smaller than the first distance. To define the spacing between the pistons 206a, 206b in the open and closed states, the actuator 200 could include one or more stroke limiting members similar to the stroke limiting members 105a, 105b described above with reference to FIGS. 2A and 2B.

As illustrated, each piston 206a, 206b includes a body portion 222a, 222b and an arm portion 224a, 224b. The body portions 222a, 222b can include generally disk-shaped members, the perimeters of which are disposed in sealing engagement with one or more interior walls of the central cylinder portion 210 of the housing 202. In some embodiments, the actuator 200 can include a seal (not shown) disposed between each of the body portions 222a, 222b and the central cylinder portion 210 of the housing 202 to provide a fluid-tight seal for enabling pneumatic operation of the actuator 200, as will be described. Similar to the body portions 122a, 122b of the pistons 206a, 206b described above with reference to FIGS. 2-4, the shape of the body portion 222a, 222b resembles that of a cross-section of the cavity 214 defined by the central cylinder portion 210 of the housing 202, which may be circular, square, rectangular, triangular, or generally any other conventional or unconventional geometric shape.

The arm portions 224a, 224b of the pistons 206a, 206b extend from the respective body portions 222a, 222b toward and beyond the shaft 204, as depicted. The arm portions 224a, 224b include pins 226a, 226b, respectively, each of which is disposed in one of the radial slots 221 formed in the yoke plate 220 of the shaft 104.

The biasing mechanism 208 of the disclosed embodiment is disposed within the cavity 214 of the housing 202 along with the shaft 204 and the pistons 206a, 206b and is operatively coupled to the shaft 204. So arranged, the biasing mechanism 208 biases the shaft 204 and the first and second pistons 206a, 206b into a predetermined relationship in a manner substantially identical to that described above regarding the biasing mechanism 108 of FIGS. 2-4. For example, in disclosed embodiment, the biasing mechanism 208 can bias the shaft 204 into the second position, thereby biasing the first and second pistons 206a, 206b together and into the closed state, as depicted in FIG. 5B. In another embodiment, however, the biasing mechanism 208 may bias the shaft 204 into the first position, thereby biasing the first and second pistons 206a, 206b apart and into the open state, as depicted in FIG. 5A. As mentioned above, the biasing mechanism 208 can be structurally and functionally identical the biasing mechanism 108 described above with reference to FIGS. 2-4 and therefore the details thereof will not be repeated.

Referring now to FIG. 6, a side view of one embodiment of the single-acting scotch-yoke actuator 200 is illustrated, wherein the biasing mechanism 208 includes first and second clock springs 228a, 228b coupled to the shaft 204. The first clock spring 228a is disposed on the shaft 204 adjacent the top shaft portion 218a, and the second clock spring 228b is disposed on the shaft 204 adjacent the bottom shaft portion 218b. Although not depicted, each of the first and second clock springs 228a, 228b is coupled between the shaft 204 and the housing 202 of the actuator 200 with an independent adjuster mechanism that can resemble the adjuster mechanism 134 described above with reference to FIG. 3A, for example. As such, the torque generated by each of the first and second clock springs 228a, 228b of the scotch-yoke actuator 200 depicted in FIG. 6 can be independently adjusted.

In this embodiment, the arm portions 224a, 224b of the pistons 206a, 206b are sized and configured to fit between the first and second clock springs 228a, 228b. Moreover, each arm portion 224a, 224b includes a top arm 225a and a bottom arm 225b, between which one of the respective pins 226a, 226b extends and connects, as illustrated in FIG. 6. So configured, the pins 226a, 226b are positioned within the radial slots 221 of the yoke plate 220 such that the pistons 206a, 206b can move between the open state (FIG. 2A) and the closed state (FIG. 2B) without interfering with the operation of the springs 228a, 228b.

During operation of the actuator 200 depicted in FIGS. 5A, 5B, and 6, the first and second clock springs 228a, 228b can naturally bias the shaft 204 into the second position shown in FIG. 5B. Because the pins 226a, 26b mounted to the arm portions 224a, 224 of the pistons 206a, 206b are disposed within the radial slots 221 of the yoke plate 220, the clock springs 228a, 228b therefore also bias the pistons 206a, 206b into the closed state, which is also depicted in FIG. 5B. To move the pistons 206a, 206b into the open state and thereby rotate the shaft 204 into the first position depicted in FIG. 5A, pressurized gas such as supply air can be delivered to the cavity 214 via an inlet 246 (shown in FIGS. 5A and 5B) in the central cylinder portion 210 of the housing 202. To return the shaft 204 to the second position and the pistons 206a, 206b to the closed state, the supply of pressurized air can be stopped, thereby allowing the clock springs 228a, 228b to urge the shaft 204 back to the position depicted in FIG. 5B.

While the scotch-yoke actuator 200 depicted in FIG. 6 includes first and second clock springs 228a, 228b, alternative embodiments could include generally any number of clock springs 228. For example, FIG. 7 depicts one alternative scotch-yoke actuator 200 that is generally the same as the actuator 200 depicted in FIG. 6 with the exception of the number of clock springs 228, the number of yoke plates 220, and the shape and configuration of the first and second pistons 206a, 206b.

Specifically, the actuator 200 depicted in FIG. 7 includes a single clock spring 228 mounted at a substantially centered position of the shaft 204 in a manner that can be identical to that described above with reference to FIG. 3A. The shaft 204 includes top and bottom yoke plates 220a, 220b, each defining a pair of radial slots that are generally identical to the radial slots 221 depicted in FIGS. 5A and 5B, but not identified by reference numeral in FIG. 7. The arm portions 224a, 224b of the pistons 206a, 206b are generally similar to the arm portions 224a, 224b depicted in FIG. 6 in that they each include a top arm 225a and a bottom arm 225b. To accommodate the centered position of the clock spring 228, however, the arm portions 224a, 224b include pins 226a extending upward from the top arms 225a into corresponding radial slots 221 of the top yoke plate 220a, and pins 226b extending downward from the bottom arms 225b into corresponding radial slots 221 in the bottom yoke plate 220b. The top and bottom arms 225a, 225b of each arm portion 224a, 224b are spaced sufficiently not interfere with the clock spring 128 when the pistons 106a, 106b move between the open and closed states depicted in FIGS. 5A and 5B.

As mentioned above, in each of the foregoing embodiments, the one or more clock springs 128, 228 can provide a constant amount of torque to the shaft 104, 204 regardless of the position of the shaft 104, 204 at or between the first and second positions. This can advantageously increase the torque output efficiency of the actuators 100, 200, thereby allowing for the use of smaller springs that generate smaller forces than the biasing mechanisms used in conventional single-acting actuators. Smaller springs can be more cost-efficient.

Another advantage of the actuators 100, 200 described herein is the fact that the biasing mechanisms 108, 208 are disposed within the same cavity 114, 214 that receives the clean pressurized air for moving the pistons 106a, 106b, 206a, 206b into the open state. As such, the springs 128, 228 are protected from any plant air or atmosphere that is drawn into and expelled through the end plates 112a, 112b, 212a, 212b, thereby optimizing their useful life.

While the actuators 100, 200 described herein each include first and second pistons, alternative embodiments of actuator constructed in accordance with the present invention could include a single piston mounted within a housing and operably connected to a rotating shaft.

What is claimed:

1. A rotary actuator comprising:
a housing defining a cavity;
a shaft disposed within the cavity of the housing and adapted for rotational displacement between a first position and a second position;
at least one piston supported within the cavity of the housing and operatively coupled to the shaft, the piston adapted for sliding displacement in association with rotational displacement of the shaft; and
at least one closed-wound power spring disposed within the cavity of the housing and operatively coupled to the shaft, the closed-wound power spring biasing the shaft and the at least one piston into a predetermined relationship.

2. The rotary actuator of claim 1, wherein the closed-wound power spring comprises a first end fixed to the shaft and a second end fixed to the housing.

3. The rotary actuator of claim 2, wherein the first end of the closed-wound power spring comprises a tongue extending at an angle to an innermost coil of the closed-wound power spring, the tongue disposed within a radial slot defined by the shaft.

4. The rotary actuator of claim 2, further comprising a threaded fastener supported by the housing and operatively coupled to the second end of the closed-wound power spring such that rotation of the threaded fastener relative to the housing adjusts the force of the closed-wound power spring.

5. The rotary actuator of claim 1, wherein the at least one piston comprises a first piston and a second piston arranged on opposite sides of the shaft, the first and second pistons slidable between a closed state when the shaft is in the first position, wherein the pistons are spaced a first distance apart, and an open state when the shaft is in the second position, wherein the pistons are spaced a second distance apart that is greater than the first distance.

6. The rotary actuator of claim 1, wherein the at least one closed- wound power spring comprises first and second closed-wound power springs disposed within the housing and operatively coupled to the shaft.

7. The rotary actuator of claim 1, further comprising an inlet defined by the housing and in fluid communication with the cavity containing the closed- wound power spring, the inlet adapted to receive a supply of pressurized air for displacing the at least one piston and shaft relative to the housing.

8. The rotary actuator of claim 1, wherein the at least one closed- wound power spring comprises at least one constant force clock spring.

9. A rotary actuator comprising:
a housing defining a cavity;
a shaft disposed within the cavity and adapted for rotational displacement relative to the housing between a first position and a second position;
at least one piston disposed within the cavity and operatively coupled to the shaft, the piston movable relative to the shaft as the shaft rotates between the first and second positions; and
a biasing mechanism coupled between the shaft and the housing and movable between a first state when the shaft is in the first position and a second state when the shaft is in the second position, wherein the biasing mechanism applies a first force to the shaft when occupying the first state and a second force to the shaft when occupying the second state, the second force being equal in magnitude to the first force.

10. The rotary actuator of claim 9, wherein the first position of the shaft is at least forty-five degrees removed from the second position of the shaft.

11. The rotary actuator of claim 10, wherein the first position of the shaft is ninety degrees removed from the second position of the shaft.

12. The rotary actuator of claim 10, wherein the first position of the shaft is one-hundred and eighty degrees removed from the second position of the shaft.

13. The rotary actuator of claim 9, wherein the biasing mechanism comprises a clock spring.

14. The rotary actuator of claim 13, wherein the clock spring comprises a first end fixed to the shaft and a second end fixed to the housing.

15. The rotary actuator of claim 14, wherein the first end of the clock spring comprises a tongue extending at an angle to an innermost coil of the clock spring, the tongue disposed within a radial slot defined by the shaft.

16. The rotary actuator of claim 14, further comprising a threaded fastener supported by the housing and operatively coupled to the second end of the clock spring such that rotation of the threaded fastener relative to the housing adjusts the force of the clock spring.

17. The rotary actuator of claim 9, wherein the at least one piston comprises a first piston and a second piston arranged on opposite sides of the shaft, the first and second pistons slidable between a closed state when the shaft is in the first position, wherein the pistons are spaced a first distance apart, and an open state when the shaft is in the second position, wherein the pistons are spaced a second distance apart that is greater than the first distance.

18. The rotary actuator of claim 9, wherein the biasing mechanism comprises first and second clock springs disposed within the housing and operatively coupled to the shaft.

19. The rotary actuator of claim 9, further comprising an inlet defined by the housing and in fluid communication with the cavity containing the biasing mechanism, the inlet adapted to receive a supply of pressurized air for displacing the at least one piston and shaft relative to the housing.

20. A rotary actuator comprising:
a housing defining a cavity;
a shaft supported in the cavity of the housing for rotational displacement between a first position and a second position removed one of approximately ninety degrees and approximately one-hundred and eighty degrees from the first position;
first and second pistons disposed within the cavity and operatively coupled to the shaft, the first and second pistons slidable between a closed state when the shaft is in the first position, wherein the pistons are spaced a first distance apart, and an open state when the shaft is in the second position, wherein the pistons are spaced a second distance apart that is greater than the first distance;
at least one clock spring disposed in the cavity and biasing the shaft into one of the first and second positions, the clock spring including a first end fixed to the shaft and a second end fixed to the housing such that the clock spring applies a constant torque to the shaft throughout the displacement of the shaft between the first and second positions.

21. The rotary actuator of claim 20, wherein the first end of the clock spring comprises a tongue extending at an angle to an innermost coil of the clock spring, the tongue disposed within a radial slot defined by the shaft.

22. The rotary actuator of claim 20, further comprising a threaded fastener supported by the housing and operatively coupled to the second end of the clock spring such that rotation of the threaded fastener relative to the housing adjusts the force of the clock spring.

23. The rotary actuator of claim 20, comprising first and second clock springs disposed within the cavity of the housing and biasing the shaft into one of the first and second positions.

24. The rotary actuator of claim 20, further comprising an inlet defined by the housing and in fluid communication with the cavity containing the clock spring, the inlet adapted to receive a supply of pressurized air for displacing the first and second pistons into one of the first and second states.
